(19) United States
(12) Patent Application Publication
(10) Pub. No.: US 2019/0036759 A1
(43) Pub. Date: Jan. 31, 2019

(54) TIMING RECOVERY FOR NYQUIST SHAPED PULSES

(71) Applicant: Roshmere, Inc., San Diego, CA (US)

(72) Inventor: Eduardo Temprana Giraldo, La Jolla, CA (US)

(73) Assignee: Roshmere, Inc., San Diego, CA (US)

(21) Appl. No.: 16/044,352

(22) Filed: Jul. 24, 2018

Related U.S. Application Data
(60) Provisional application No. 62/538,151, filed on Jul. 28, 2017.

(51) Int. Cl. H04L 27/38; H04B 1/16; H04L 7/033

(52) U.S. Cl. CPC H04L 27/38; H04L 7/0334; H04B 1/16

(57) ABSTRACT

Timing recovery systems and methods can include receiving a signal with Nyquist shaped pulses, sampling the signal using an analog-to-digital converter at a sampling rate, generating a plurality of delayed sampled signals from the received pulses, resampling each delayed sampled signal to 1 sample per symbol, taking the absolute value of each resampled signal, raising the absolute value of each resampled signal to the fourth power, taking the mean of the fourth power of the absolute value of each resampled signal, feeding all of the mean values into a phase estimator, and using the output from the phase estimator for timing correction. The output from the phase estimator can either be fed back to the analog-to-digital converter, or to an interpolation stage that adjusts sampling instants of the sampled signals output from the analog-to-digital converter, to correct the timing.

### RELATED APPLICATIONS

The application claims the benefit of U.S. Provisional Patent Application No. 62/538,151 filed on Jul. 28, 2017 and entitled “TIMING RECOVERY FOR NYQUIST-LIKE SHAPED PULSES;” which is hereby incorporated in its entirety by reference for all purposes.

### BACKGROUND

Timing recovery in binary electronics and communication systems with Nyquist shaped pulses can be accomplished using techniques such as the Gardner method. This method is limited since it is not very effective in higher order modulation schemes (e.g., QAM-16). In addition to requiring two samples per symbol, the Gardener method uses an algorithm that requires knowledge of the previous symbol's timing to estimate the timing error for the current symbol.

Electronics and communication systems with Nyquist shaped pulses using higher order modulation schemes often require pulse shaping, such as from a raised-cosine pulse shaping filter. In some cases, the pulse shaping can include a roll-off-factor (ROF) that is less than 0.1, which causes typical timing recovery systems and methods to be inadequate.

A timing recovery method that is independent of ROF has been described for electronics and communication systems with Nyquist shaped pulses that use higher order modulation schemes. That method includes extracting a clock tone from a signal, employing a phase-locked loop (PLL) to track the phase of the clock tone, and using a voltage controlled oscillator (VCO) to clock the system.

### SUMMARY

In some embodiments, a timing recovery method comprises a.) receiving a signal comprising Nyquist shaped pulses, b.) sampling the signal using an analog-to-digital converter (ADC) at a sampling rate, c.) generating a plurality of delayed sampled signals from the sampled signal, wherein each delayed sampled signal has a sampling rate and a different sampling delay, d.) resampling each delayed sampled signal to 1 sample per symbol, e.) taking the absolute value of each resampled signal, f.) raising the absolute value of each resampled signal to the fourth power, g.) taking the mean of the fourth power of the absolute value of each resampled signal, h.) feeding all of the mean values into a phase estimator, and i.) using an output from the phase estimator for timing correction.

In some embodiments, the timing recovery method described above further comprises feeding the output of the phase estimator back to the ADC for timing correction.

In other embodiments, the timing recovery method described above further comprises feeding the output of the phase estimator to an interpolating stage for timing correction, wherein the interpolating stage adjusts sampling instants of the sampled signals output from the analog-to-digital converter to have corrected timing.

In some embodiments, a timing recovery method comprises a.) receiving a signal comprising Nyquist shaped pulses, b.) sampling the signal using an ADC at a sampling rate to generate a sampled signal, c.) delaying the sampled signal using a sampling delay to generate a delayed sampled signal, d.) resampling each delayed sampled signal to 1 sample per symbol, e.) determining an absolute value of each resampled signal, f.) raising the absolute value of each resampled signal to the fourth power, g.) taking the mean of the fourth power of the absolute value of each resampled signal, h.) adjusting the sampling delay and repeating steps a.) through g.) with the adjusted sampling delay N times before proceeding to step i.) to generate N sampled signals with N delays, i.) feeding the N sampled signals with N delays into a phase estimator, and j.) using an output from the phase estimator for timing correction.

In some embodiments, the timing recovery method described above further comprises feeding the output of the phase estimator back to the ADC for timing correction.

In other embodiments, the timing recovery method described above further comprises feeding the output of the phase estimator to an interpolating stage for timing correction, wherein the interpolating stage adjusts sampling instants of the sampled signals output from the analog-to-digital converter to have corrected timing.

In some embodiments, a timing recovery method comprises a.) receiving a signal comprising Nyquist shaped pulses, b.) sampling the signal using an ADC at a sampling rate using a sampling offset to generate a sampled signal, c.) determining an absolute value of the sampled signal, d.) raising the absolute value of the sampled signal to the fourth power, e.) generating a spectral domain representation of the absolute value of the sampled signal, f.) determining a dominant signal energy peak in the spectral domain, and g.) maximizing the dominant signal energy peak amplitude in the spectral domain by adjusting the sampling offset.

In some embodiments of the timing recovery method described above, the adjusting the sampling offset to maximize the dominant signal energy peak amplitude in the spectral domain further comprises determining multiple signal energy values of the dominant signal energy peak in the spectral domain which correspond to multiple respective sampling offsets, fitting a sinusoidal function to the multiple signal energy values, and using the sinusoidal function to determine a sampling offset that maximizes the dominant peak signal energy amplitude in the spectral domain.

In some embodiments of the timing recovery method described above, the sampling offset that maximizes the dominant signal energy peak amplitude in the spectral domain is fed back to the ADC for timing correction.

In other embodiments of the timing recovery method described above, the sampling offset that maximizes dominant the signal energy peak amplitude in the spectral domain is fed to an interpolating stage for timing correction, wherein the interpolating stage adjusts sampling instants of the sampled signals output from the analog-to-digital converter to have corrected timing.

### BRIEF DESCRIPTION OF THE DRAWINGS

FIGS. 1A and 1B show a signal in the time domain with the signal amplitude on the vertical axis and time in the horizontal axis.

FIGS. 1C and 1D show frequency domain representations of signals.

FIG. 2A shows a block diagram of an example of an electrical system, in accordance with some embodiments.

FIG. 2B shows a block diagram of an example of an electrical system, in accordance with some embodiments.

FIG. 2C shows an example implementation of a timing recovery system for use in the electrical system shown in FIG. 2A or FIG. 2B, in accordance with some embodiments.

FIGS. 3A-3B illustrate an example timing recovery system sampling a signal with a perfect timing alignment.

FIGS. 4A-4B illustrate an example timing recovery system sampling a signal with an imperfect timing alignment.

### DETAILED DESCRIPTION

Electrical systems, radio-frequency (RF), and optoelectronic communication systems benefit from higher order modulation schemes and pulse shaping with tight spectral occupancy. In practice, this typically corresponds to systems employing small excess bandwidth (i.e., low roll-off-factor (ROF)) raised cosine (RC), or root-raised cosine (RRC) pulse shaped information-bearing waveforms. Timing recovery in systems employing such waveforms is challenging, and standard solutions such as those based on the Gardener method fail. Timing recovery systems using phase-locked loops (PLLs) and voltage controlled oscillators (VCOs) are complicated and difficult to implement in high speed commercial systems.

The timing recovery systems described herein can be applied to radio frequency (RF) and optoelectronic communication systems with higher order modulation schemes and pulse shaping for Nyquist pulses (i.e., pulses that satisfy the Nyquist ISI criterion) with low roll-off-factors (ROFs), and that do not require PLLs or VCOs. Some non-limiting examples of pulse shaping filters for Nyquist pulses in high-speed communication systems that can have low ROFs are raised-cosine filters, root-raised-cosine, Gaussian filters, and sinc filters. In some embodiments, the pulse shaping filters to generate Nyquist pulses, such as those listed above, can function as frequency-domain filters and/or temporal pulse shaping elements. Another benefit of the timing recovery systems and methods described herein is that oversampling beyond Nyquist frequency is not needed, even for signals with a small ROF (e.g., less than 0.1). There are several advantages of sampling at lower rates (e.g., less than 2 samples per symbol (s.p.s.), or between 1+beta s.p.s. and 2 s.p.s., where beta is the ROF of the filters used to pulse shape the information-bearing waveforms) in communication systems, including a reduction in the power required by the system, and the ability to use less powerful system components, which can reduce the cost to implement and operate the system.

In some embodiments, the signal s(t) that is input into the timing recovery systems and methods described herein is a modulated signal with Nyquist pulses. In some embodiments, the modulated signal with Nyquist pulses is a pulse-amplitude modulated (PAM) signal, or a quadrature amplitude modulated (QAM) signal. In some embodiments, the signal is a quadrature phase shift keying (QPSK) signal, or an 8 QAM signal, or a higher order QAM signal (e.g., a 16 QAM signal, or a 32 QAM signal, or a 64 QAM signal, or a 128 QAM signal, or a 256 QAM signal).

In some embodiments, the signal s(t) that is input into the timing recovery systems and methods described herein is a digitally modulated signal with Nyquist pulses. In some embodiments, the signal contains pulses that are frequency filtered and/or temporally shaped using a raised-cosine filter, a root-raised-cosine pulse shape, a Gaussian filter, a super-Gaussian filter, or a sinc filter. In some embodiments, the signal s(t) is a digitally modulated signal with pulse shaping using a pulse shaping filter having a roll-off factor less than 0.5, or less than 0.2, or less than 0.1, or less than 0.01, or from 0.001 to 0.2. In some embodiments, the signal s(t) is a digitally modulated signal with pulse shaping using a raised-cosine filter having a roll-off factor less than 0.2, or less than 0.1, or less than 0.01, or from 0.001 to 0.2.

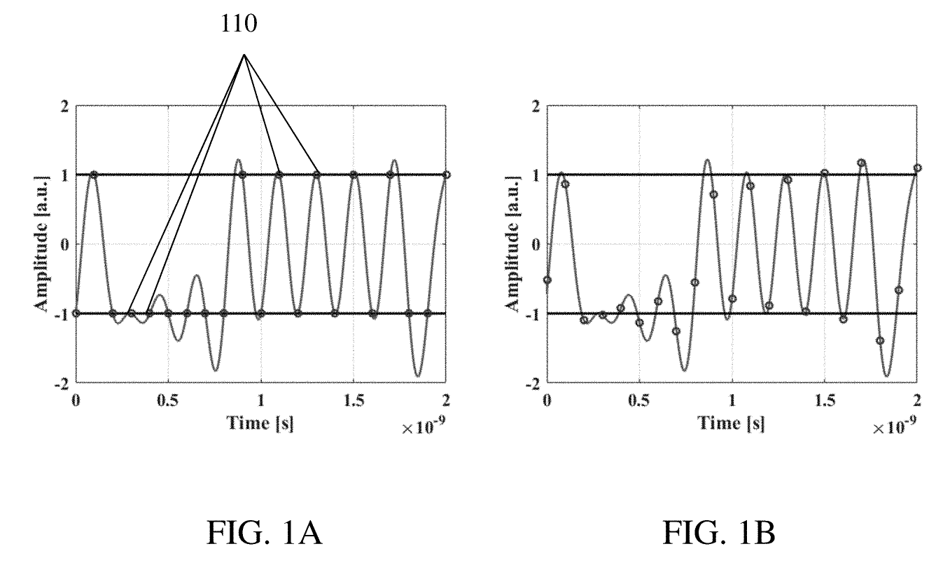

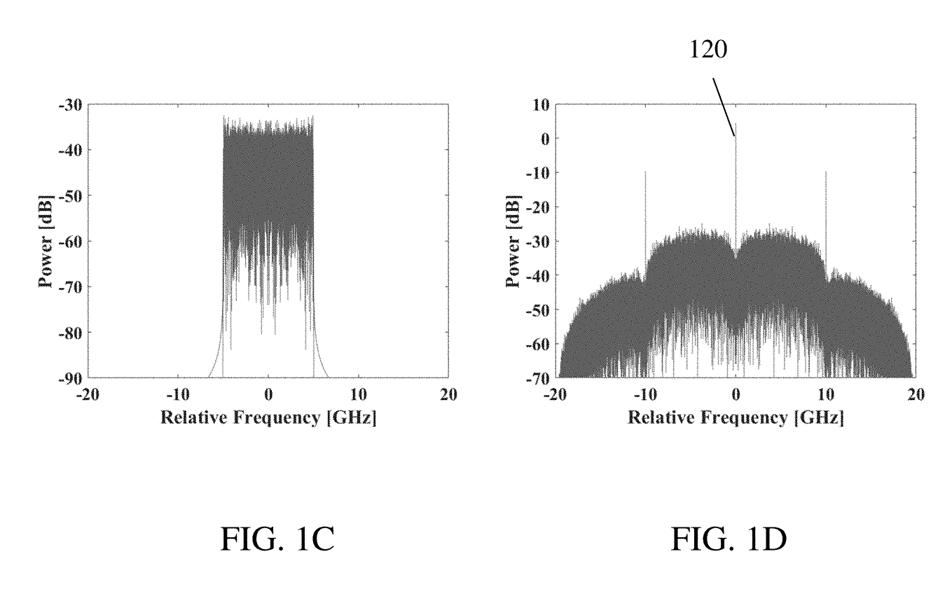

FIGS. 1A and 1B show examples of signals in the time domain with the signal amplitude on the vertical axis and time on the horizontal axis. Circles 110 in FIGS. 1A and 1B show instants at which the signals are sampled to create a “sampled signal”. The sampling rate is the number of samples taken per unit of time, or approximately one sample per 0.1 ns in these examples. The signal in FIG. 1A is sampled with perfect time alignment, i.e., the sampled signals have sampled points with amplitudes that are either positive or negative 1. The signal in FIG. 1B, on the other hand, is sampled with imperfect time alignment, i.e., the sampled signals have sampled points with varying amplitudes that deviate from positive or negative 1. The timing recovery systems and methods described herein optimize the alignment of the sampling instants for a given signal to maximize signal to noise, minimize intersymbol interference, and in general to maximize the performance (or, equivalently minimize the bit-, symbol-, or frame-error rate), so that regardless of whether the samples are taken with perfect or imperfect alignment, the timing recovery system is capable of accurately recovering the timing. The timing recovery systems and methods described herein are particularly useful for high-speed signal transmission systems, since the intersymbol interference and performance (e.g., bit-, symbol-, or frame-error rates) are typically more problematic at higher modulation rates.

In general, timing recovery using the systems and methods described herein can be implemented using time domain operations, frequency domain operations, or a combination of both. In some embodiments of the time domain and frequency domain implementations, an oversampled input signal is sampled to create sampled signals with different sampling delays (i.e., different sampling offsets). Oversampling can be performed at a rate equal to the Nyquist frequency (i.e., at 1+beta samples per symbol (s.p.s.), where beta is the ROF of the filters used to pulse shape the information-bearing waveforms). For example, in the case where a system uses an RRC pulse shaping filter with an ROF equal to 0.1, then oversampling at 1.1 s.p.s. can be used. Oversampling can also be performed at a rate greater than the Nyquist frequency (e.g., at 2 s.p.s.), however, oversampling at a rate beyond the Nyquist frequency is not required. In some embodiments, each sampled signal is then decimated to 1 s.p.s., the absolute value is taken and raised to the fourth power, then the mean is taken, and then the collection of mean values are fed into a phase estimator with their corresponding delays to determine the optimal sample timing. In some embodiments of the time domain implementation of the timing recovery method, a series of points is generated by transforming the delayed sampled signals that are related to the symbol timing. The series of points is then used to optimize the sampling timing. In some embodiments of the frequency domain implementation of the timing recovery method, a peak in the transformed frequency spectrum of the sampled signal is used to optimize the sampling timing. The time domain and the frequency domain systems and methods are described more completely below.

FIGS. 1C and 1D show examples of frequency domain representations of signals, with power on the vertical axis and relative frequency on the horizontal axis. The signals used to generate these plots were higher order modulated signals with modulation rate of approximately 10 Giga Baud (GBd), and pulse shaping was accomplished using a raised-cosine filter with a ROF less than 0.1. FIG. 1C was generated by taking a discrete Fourier transform (DFT), or fast Fourier transform (FFT), of the signal in the time domain. FIG. 1D was generated by first transforming the signal by taking the absolute value of the signal in the time domain, raising the absolute value of the signal to the fourth power, and then taking the FFT. As shown, the absolute value and fourth power operations used to transform the signal has created a dominant peak 120 at the center of the spectrum (i.e., approximately at 0 GHz frequency).

The amplitude of the dominant peak at the center of the spectrum rises and falls over the time interval of one symbol period. The phase of the rising and falling of the amplitude of this peak corresponds to the phase of the symbol timing in the data pattern. In other words, the timing of the information stream can be reconstructed from the pulse itself. The timing recovery systems and methods described herein utilize this relationship to optimize the sample timing. On the other hand, a conventional timing recovery method for signals with higher order modulation schemes employing pulse shaping with low ROFs extracts the clock tone directly from the side band amplitude fluctuations (since the clock tone is in the side band and not in the center of the frequency spectrum). As can be seen in FIG. 1D, after the transformations described above, the power in the sidebands is relatively weak compared to the power in the dominant peak at the center of the spectrum (e.g., 10-20 dB lower). Furthermore, timing recovery using the sidebands may require a system with a phase-locking element, which is more complicated than a timing recovery system that uses the dominant peak and advantageously uses a simple power measurement element. Therefore, the systems and methods described herein can attain better signal to noise and better performance (e.g., lower bit-, symbol-, or frame-error rate) with less complexity than systems and methods utilizing the clock tone in the side bands for timing recovery with low ROFs. In some embodiments, the signal-to-noise ratio (SNR) is on the order of 20 times better than in a conventional system. In the frequency domain, the SNR improvement is on the order of 20 dB.

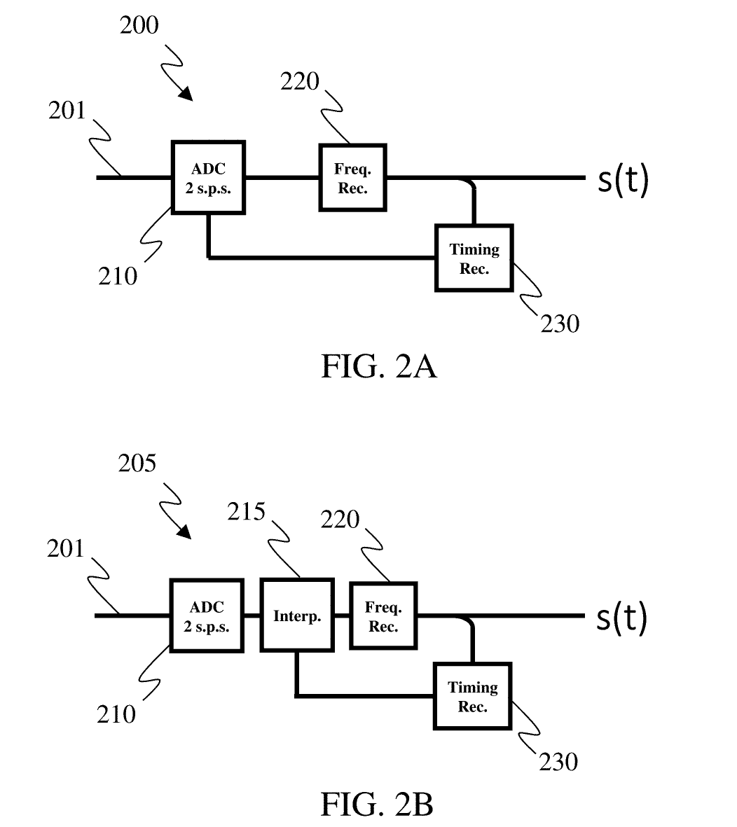

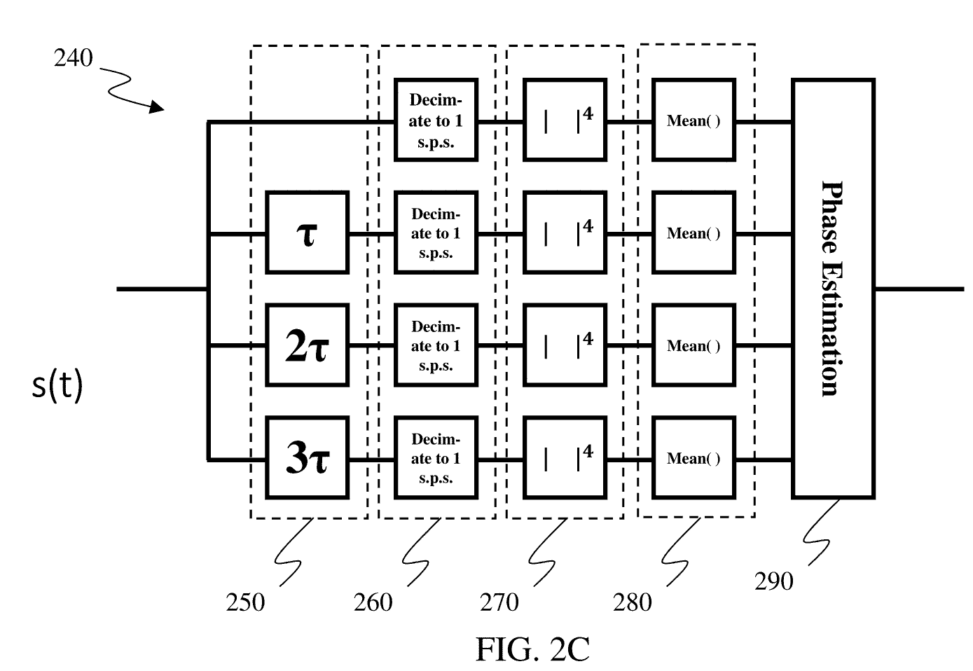

FIG. 2A shows a block diagram of an example of an electrical system 200 with an analog-to-digital converter (ADC) 210 that is initially sampling a signal 201 at 2 samples per symbol (s.p.s.). In some embodiments, the signal 201 sampled by the ADC 210 is a signal containing Nyquist shaped pulses (i.e., Nyquist pulses). A frequency recovery is performed by processing block 220 after the ADC to generate a baseband signal s(t). Timing recovery is performed by processing block 230 on the signal s(t) in the digital domain (e.g., with digital signal processing (DSP)), and the output from the timing recovery system or operation is fed back to the ADC 210 to adjust the sampling timing (e.g., by changing the clock of the ADC that controls the instants when the ADC samples the signal). In some embodiments, the signal can be initially sampled at less than 2 s.p.s. (provided the sampling frequency is greater than the Nyquist frequency, as described above), or more than 2 s.p.s. at the ADC (e.g., by the ADC 210 in FIG. 2A). In some embodiments, the signal can be initially sampled at less than 2 s.p.s. and be up-sampled before the timing recovery is performed.

Frequency recovery is equivalent to down converting the signal down to DC in the digital domain. If frequency recovery is performed in the system (e.g., as shown in processing block 220 in FIG. 2A), then the timing recovery can be performed both in the time domain or in the frequency domain. In the cases where frequency recovery is not performed (e.g., if processing block 220 were omitted from the system shown in FIG. 2A), then timing recovery can still be performed in the frequency domain.

FIG. 2B shows a block diagram of an example of an electrical system 205 that contains the same elements as in FIG. 2A with the addition of an interpolation processing block 215. In some embodiments, as shown in FIG. 2B, the output from the timing recovery processing block 230 can be fed to an interpolating stage 215 to recover the timing. In the system 200 in FIG. 2A, the output from the timing recovery processing block 230 is used to reset the sampling instant at the ADC 210 so that future sampled symbols will be sampled with the corrected timing. Alternatively, as shown in system 205 in FIG. 2B, the interpolating stage can take the output from the timing recovery processing block 230 and apply the timing correction to symbols that have already been sampled by interpolating between the ADC samples. In some embodiments, the interpolation processing block 215 interpolates between the ADC samples using a sinc interpolation, where the output from the timing recovery processing block 230 provides the timing offset for the sinc interpolation. For example, FIG. 1B shows a signal that is imperfectly sampled (i.e., there is a timing offset between the sampled instants and the optimal sampling instants). In this example, the timing recovery processing block 230 calculates a timing offset value (i.e., calculates a value by which the ADC sampling timing is offset from the optimal sampling timing), and the interpolation block 215 uses the calculated timing offset value to interpolate (e.g., using sinc interpolation) between the imperfectly sampled instants (i.e., those shown in FIG. 1B) and sample the points at the corrected sampling instants (i.e., those shown in FIG. 1A). In another example, 100 symbols are sampled by the ADC 210 (i.e., 100 symbols within a signal are sampled over a period of time), and these sampled symbols are used to calculate the phase offset of the sampling in the timing recovery processing block 230. The output from the timing recovery processing block 230 is the phase shift needed to correct the timing. In this example, that output is fed to the interpolating processing block 215 that will allow the timing for the sampled symbols to be corrected (e.g., using sinc interpolation). In other words, the interpolating processing block 215 allows the system to adjust the sampling instants of the processed symbols with the corrected timing.

In some embodiments, the timing recovery process is used to initialize the sample timing for the system. In some embodiments, the timing recovery process is performed periodically to correct the sample timing for the system. In some embodiments, the timing recovery process is performed continuously, continually, or at periodic intervals. In some embodiments, the timing recovery process includes operating on (e.g., taking the mean of) a group of 50 symbols, or 100 symbols, or 1000 symbols, or a group of any other appropriate number of symbols. In some embodiments, the timing recovery process described herein can be performed periodically, at a frequency of once for every 50 symbols, or 100 symbols, or 1000 symbols, or once per any other interval.

FIG. 2C shows an example implementation of a timing recovery system 240, which can be used as the clock recovery 230 in FIG. 2A or FIG. 2B. The signal s(t) is delayed by different amounts (in processing blocks 250) in a pipeline implementation of sweeping. In the example shown in FIG. 2C, 4 delayed sampled signals are generated with different delays (or offsets) by sampling the signal at a given instant (i.e., where the delay added in processing block 250 is 0 seconds) to generate the first delayed sampled signal, and then delaying the sampling instant by an amount of time τ to generate the second delayed sampled signal, and then delaying the sampling instant by 2τ to generate the third delayed sampled signal, and then delaying the sampling instant by 3τ to generate the fourth delayed sampled signal. After delaying the signal sampling, the delayed sampled signals are decimated (in processing blocks 260) to 1 s.p.s.

Continuing with FIG. 2C, the decimated delayed sampled signals with different delays are transformed by taking the absolute value and raising the absolute value to the fourth power (in processing blocks 270). As was shown in FIGS. 1C and 1D, the fourth power of the absolute value transformation creates a dominant peak at the center of the spectrum in frequency space. The mean of each of the delayed transformed signals is then taken (in processing blocks 280). The series of means that is created by the delayed sampling and transformations above forms a set of values that is related to the clock tone. These points are then fed into a phase estimator processing block 290, which uses the phase of the oscillation of the amplitude of those points to determine the optimal sample timing of the system. The phase estimator output can then be used to set or reset the sample timing of the system (e.g., as feedback for the ADC 210 in FIG. 2A).

If frequency recovery is performed before timing recovery (e.g., if processing block 220 is used before processing block 230 as shown in FIG. 2A), then the dominant peak created by the fourth power of the absolute value transformation will be exactly at the center of the spectrum in frequency space (i.e., at 0 Hz). If, however, frequency recovery is not performed before timing recovery (e.g., if processing block 220 in FIG. 2A is omitted), then this dominant peak will be shifted from the center of the spectrum in frequency space. In cases where the dominant peak is shifted from the center of the spectrum in frequency space, timing recovery can still be performed in the frequency domain by adding an extra step to find the peak maximum in the spectral domain (e.g., by performing an FFT on the signal and finding the maximum in the spectral domain).

In some embodiments, a timing recovery method can be performed using the system described above. In some embodiments, the method includes receiving a signal with Nyquist pulses, generating a plurality of delayed sampled signals, decimating each sampled signal to 1 sample per symbol, taking the absolute value of each decimated signal, raising the absolute value of each decimated signal to the fourth power, taking the mean of the fourth power of the absolute value of each decimated signal, feeding all of the mean values into a phase estimator to determine the optimal sample timing of the system, and feeding the output from the phase estimator back to the ADC for timing correction (e.g., as feedback for the ADC 210 in FIG. 2A). The plurality of delayed sampled signals each have a sampling rate, by which the signal is sampled a certain number of times per second (or number of samples per symbol). The plurality of delayed sampled signals also have different sampling delays, determining the instants that the signal is sampled. The timing recovery method thereby ensures the optimal sampling instant to maximize signal to noise, minimize intersymbol interference, and maximize the performance.

The transformed Nyquist pulse amplitudes with different sampling delays generated by the above method have the same phase as the symbol timing and therefore are used for timing recovery.

In some embodiments of the timing recovery systems and methods above, the signal is delayed (in some cases one of the delays includes no delay, as shown in the example in FIG. 2C) 4 times, or more than 4 times, or 6 times, or 8 times, or 10 times, or from 4 to 10 times. In some cases, the signal can be delayed 3 times, and timing recovery can be performed. In some cases, delaying the signal 3 times can result in reduced timing recovery accuracy compared to cases where the signal is sampled using 4 or more delays. In some cases, this is because the sinusoidal fitting is less accurate if there are fewer than 4 sampled values. In some embodiments of the timing recovery systems and methods above, the signal is delayed N times, where N is 4 or more, and each delay is 1/N of the symbol period. For example, the signal can be delayed 4 times: 0/4 of the symbol period, 1/4 of the symbol period, 1/2 of the symbol period, and 3/4 of the symbol period. In some embodiments, the signal is delayed N times, where N is 4 or more, and each delay is less than 1/N of the symbol period. In such cases, the delayed signals will not sample the entire symbol period. In some cases, sampling less than a full symbol period can result in reduced timing recovery accuracy compared to cases where the whole symbol period is sampled. In some cases, this is because the sinusoidal fitting is less accurate if the sampled values do not cover the entire period.

In some embodiments, the signals input into the timing recovery systems and methods described herein are initially oversampled at a rate of 2 s.p.s. In some embodiments, the signals are oversampled from 1 to 2 times the Nyquist frequency (i.e., 1 to 2 times above twice the signal frequency), or greater than 1 times the Nyquist frequency, or greater than 1.2 times the Nyquist frequency, or greater than 1.1 times the Nyquist frequency, or greater than 1.01 times the Nyquist frequency.

In some embodiments of the timing recovery systems and methods above, after the signal s(t) is delayed by different amounts (e.g., in processing blocks 250), the delayed sampled signals are resampled to 1 s.p.s. Decimation, as described above, can be used when the signal is initially sampled at 2 s.p.s. and 1 s.p.s. is discarded. When the signal is sampled at less than 2 s.p.s., or at a value that is not 2 s.p.s., then other types of resampling can be used (e.g., at processing block 260 in FIG. 2C), such as sinc interpolation.

In some embodiments of the timing recovery systems and methods above, the phase estimation processing block 290 fits the sampled mean values of each of the delayed transformed signals to a sinusoidal function. In some embodiments, the phase estimator fits the sampled mean values to a different function, such as a saw-tooth function, or a continuous polynomial function, or a piece-wise continuous polynomial function. In some embodiments, the phase estimator fits the sampled mean values to a relationship contained in a look-up-table (LUT) that may or may not be described by a mathematical function. In some embodiments, the phase estimator uses a least mean square algorithm, or a root mean square algorithm, to fit the sampled mean values to a signal function.

Additionally, a timing recovery process in the time domain can be accomplished using a set of looped operations, rather than a parallel pipeline set of operations as described above. Many of the unit operations in the process using looped operations are the same as those in the process using parallel operations, however, the phase estimation procedure can be somewhat different. The system for the timing recovery using looped operations is also somewhat different than the system in FIG. 2C that is used for timing recovery using parallel operations. In the case of a system for the timing recovery using looped operations, there is only one branch containing processing blocks similar to 250, 260, 270 and 280 in FIG. 2C, and the signal s(t) is delayed by different amounts in the processing block similar to 250 and each of the differently delayed transformed signals are serially fed into the phase estimator. In some embodiments, a timing recovery method can include: receiving a signal of Nyquist shaped pulses; sampling the signal using an ADC at greater than or equal to the Nyquist frequency; delaying the signal using an initial sampling delay; resampling (e.g., decimating) each delayed sampled signal to 1 s.p.s.; determining an absolute value of the decimated signal; raising the absolute value of the decimated signal to the fourth power; taking the mean of the fourth power of the absolute value of each decimated signal; adjusting the sampling delay; feeding the sampled signals with adjusted delays into a phase estimator; and using the output from the phase estimator for timing correction. In some embodiments, the phase estimator fits the signals sampled with different delays to a function (as described above) in order to correct the timing and maximize the performance of the system. Alternatively, in some embodiments, the phase estimator uses an iterative process where the sampling delay is adjusted until the performance is maximized.

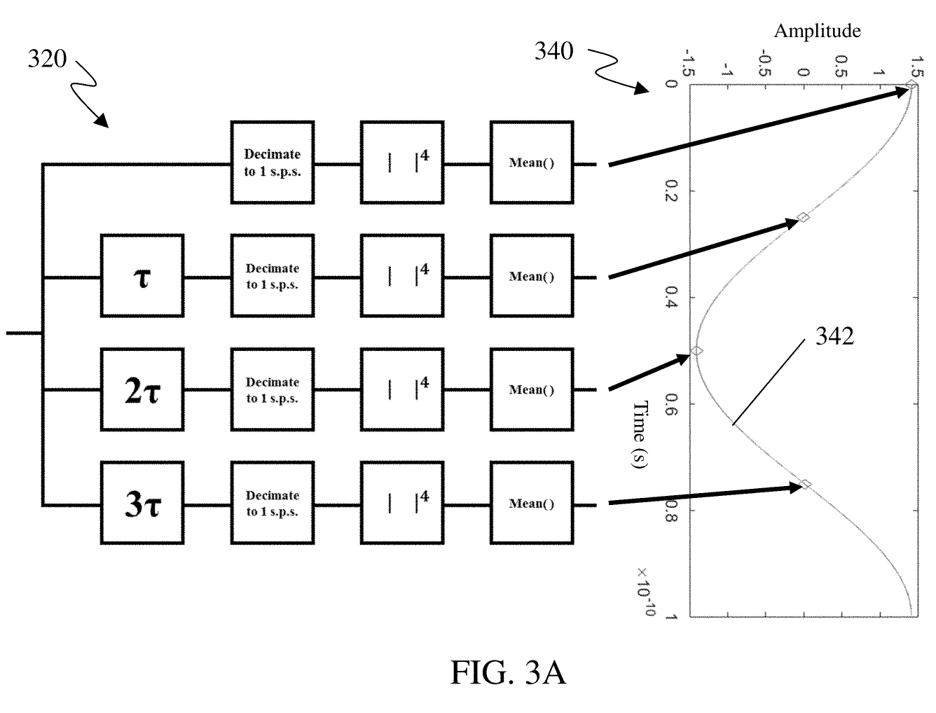

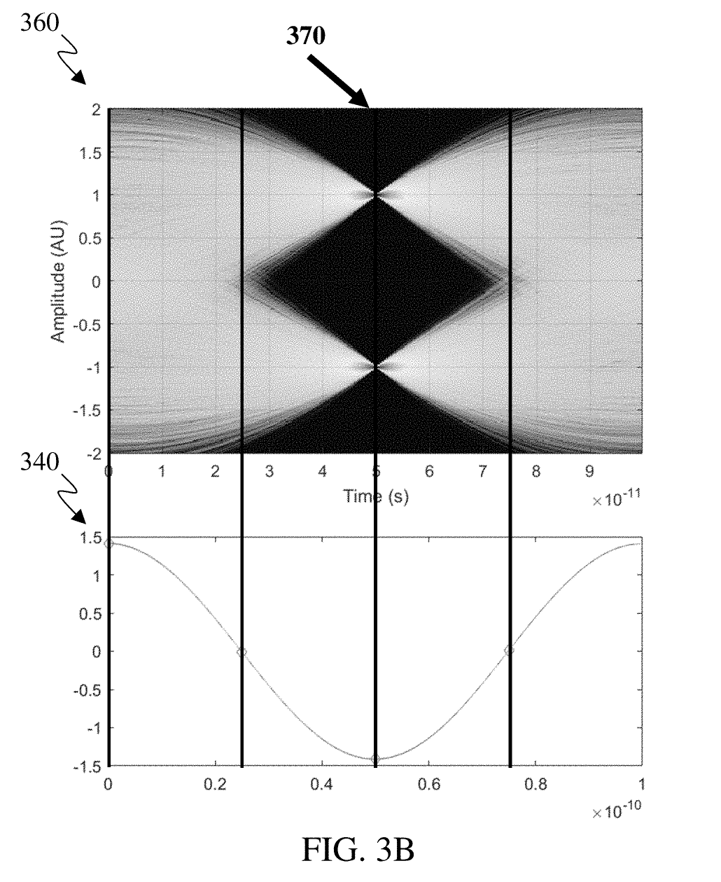

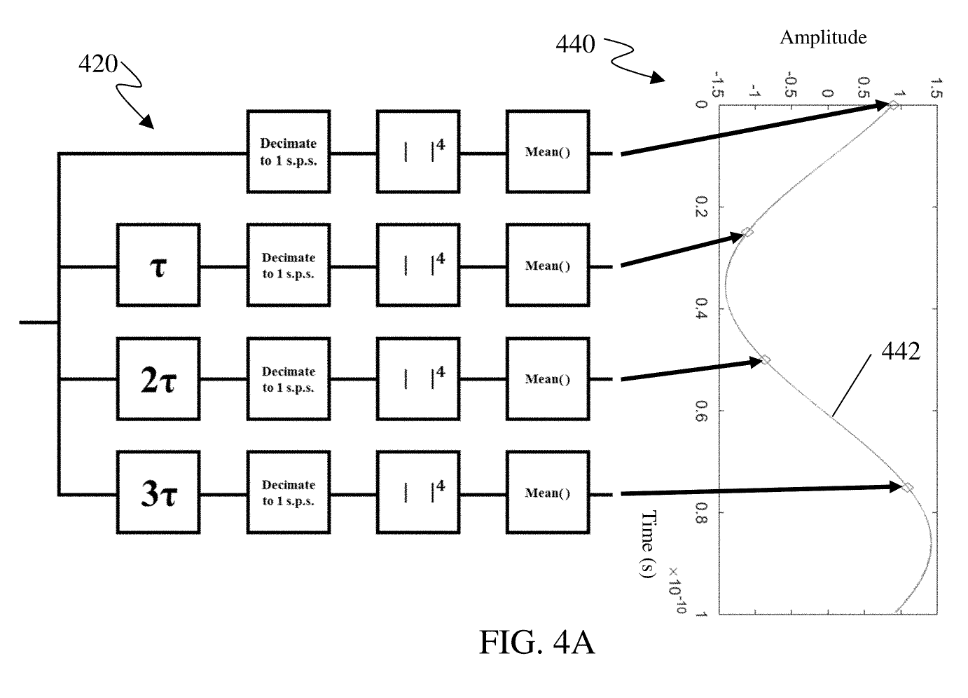

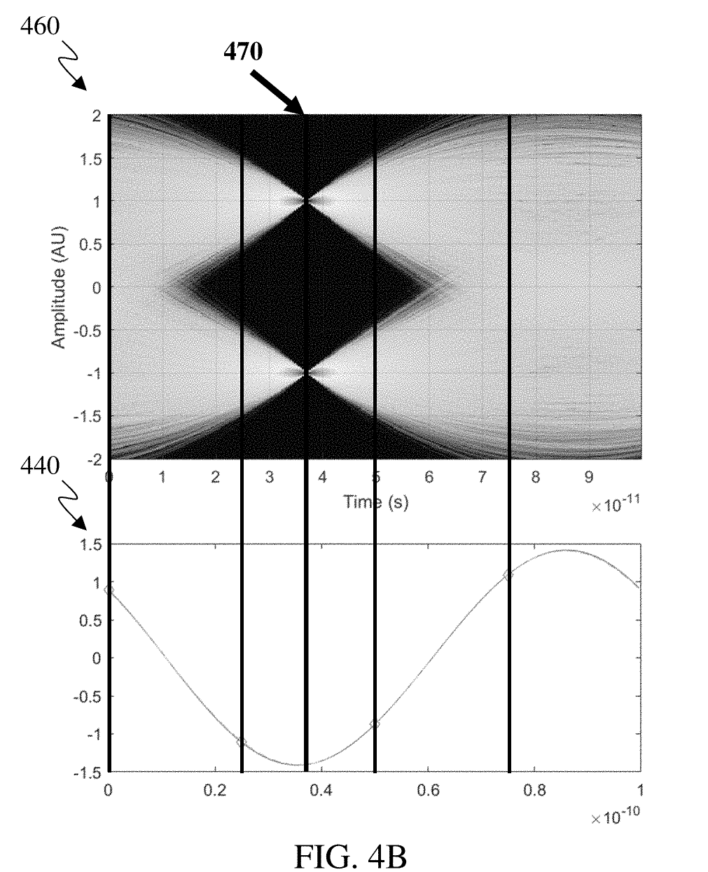

FIGS. 3A-3B and FIGS. 4A-4B illustrate two examples of the timing recovery systems and methods described above.

FIGS. 3A-3B illustrate an example timing recovery system sampling a signal with perfect timing alignment. FIG. 3A shows a timing recovery system 320 similar to that in FIG. 2C discussed above. The signal input into the system 320 corresponds to the signal shown in FIG. 1A, and the signal is sampled with perfect timing, similar to the example shown in FIG. 1A. As shown in system 320, the first sampling of the signal is taken with a delay of zero, and subsequent samplings of the signal are delayed by different amounts (0, τ, 2τ, and 3τ) corresponding to 0/4 of the symbol period, 1/4 of the symbol period, 1/2 of the symbol period, and 3/4 of the symbol period. In system 320, similarly to system 240 discussed above, each of the signal samples is decimated to 1 s.p.s, and the absolute values of the decimated samples are taken and raised to the fourth power. Then the mean of the samples is taken, and the mean values of each of the delayed transformed signals are shown as points in the plot 340 in the figure, as indicated by the four arrows. The plot 340 shows the mean values of each of the delayed transformed signals in the time domain with the signal amplitude on the y-axis and time on the x-axis after mean subtraction and normalization. The time axis in plot 340 spans 1 symbol period. The four points in this example are fit to a sinusoidal function 342 to determine the phase of the sampling timing (e.g., by performing operations using a phase estimator similar to those described above in reference to processing block 290 in system 240). The phase of the sinusoidal function 342 can then be fed back to the ADC (e.g., element 210 in system 200) for establishing sample timing, for sample timing correction, or for maintaining sample timing. Alternatively, the phase information can be provided, as feedback, to an interpolation stage (e.g., the interpolation processing block 215 in FIG. 2B) to correct the timing of previously sampled signals.

FIG. 3B shows the mean values of each of the delayed transformed signals in the time domain according to the plot 340, and an eye diagram 360 of the signal with the signal amplitude on the vertical axis and time on the horizontal axis. FIG. 3B illustrates that the signal in this example was sampled with perfect time alignment, since the sampled points align perfectly with the extrema of the fitted sinusoidal function (i.e., the minimum in plot 340), which in turn aligns perfectly with the center of the eye diagram 360. The instant in the eye diagram 360 corresponding to the ideal sampling instant 370, the center of the eye diagram in this example, is the point with the least intersymbol interference, which is manifest as two distinct points in the eye diagram at amplitudes of +1 and −1.

FIGS. 4A-4B illustrate an example of a timing recovery system sampling a signal with imperfect timing alignment. FIG. 4A shows a timing recovery system 420 similar to that in FIG. 2C and FIG. 3A discussed above. The signal input into the system 420 corresponds to the signal shown in FIG. 1B, and the signal is sampled with imperfect timing, similar to the example shown in FIG. 1B. As in the example of FIG. 3A above, the first sampling of the signal is taken with a zero delay, and subsequent samplings of the signal are delayed by different amounts (τ, 2τ, and 3τ). Each of the signal samples is decimated to 1 s.p.s. (sample per symbol), the absolute values taken and raised to the fourth power, and then the means taken. The mean values of each of the delayed transformed signals is also shown in the plot 440 in the figure, as indicated by the four arrows. The plot 440 shows the mean values of each of the delayed transformed signals in the time domain with the signal amplitude on the y-axis and time in the x-axis after mean subtraction and normalization. The four points in this example are fit to a sinusoidal function 442 to determine the phase of the sampling timing (e.g., by performing operations using a phase estimator similar to those described above in reference to processing block 290 in system 240). The phase of the sinusoidal function 442 can then be fed back to the ADC (e.g., element 210 in system 200) for establishing sample timing, for sample timing correction, or for maintaining sample timing.

FIG. 4B shows the mean values of each of the delayed transformed signals in the time domain according to the plot 440, and an eye diagram 460 of the signal with the signal amplitude on the vertical axis and time on the horizontal axis. FIG. 4B illustrates that the signal in this example was sampled with imperfect time alignment, as opposed to the perfect time alignment for the example in FIG. 3B. The extrema (i.e., the minimum in plot 440) indicates the ideal sampling instant 470; however, in this case the ideal sampling instant 470 does not align with any of the sampled instants (i.e., any of the delayed sampled signals). None of the four delayed sampling instants were perfectly aligned with the ideal sampling instant 470. Therefore, in this case the points are fit to the sinusoidal function, and the difference between the extrema of the function and one of the delayed sampling instants can be used to adjust the phase of the sampling. That phase information can be used to correct, or recover, the timing (e.g., as feedback to the ADC 210 in FIG. 2A, or as feedback to the interpolation processing block 215 in FIG. 2B to correct the timing of previously sampled signals).

In some embodiments, a timing recovery method includes down converting a set of transformed signals down to DC (e.g., as is accomplished using frequency recovery processing block 220 in FIG. 2A). In some embodiments, a timing recovery method includes receiving a signal, sampling the signal using an ADC using an initial sampling offset, down converting the sampled signal down to DC, delaying the down converting and down sampled signal by different amounts, resampling the delayed signals to 1 s.p.s., determining an absolute value of each delayed resampled signal, raising the absolute value of each delayed resampled signal to the fourth power, determining the mean of the 4^{th} power-raised signals, fitting the means of the 4^{th} power-raised signals to a sinusoidal function to determine the phase of the sampling timing, and then adjusting the sampling offset (e.g., in the ADC) such that the one or more of the sampled points align with the extremum of the fitted sinusoidal function (e.g., as shown in 340 and 360 in FIG. 3B). Down converting the signal down to DC guarantees that the mean is equivalent to the power of the tone that appears in the frequency domain, which in the down-converted case will be at DC, and is equivalent with the embodiments in the previous section.

In some embodiments of the timing recovery method above, adjusting the sampling offset such that the fitted sinusoidal function has a desired phase includes: a.) determining four or more multiple transformed signal values at DC (e.g., 4, or 6, or 8, or 10, or from 4 to 10) that correspond to multiple respective sampling delays, b.) fitting a sinusoidal function to the multiple delayed and transformed signal values and determining a calculated phase of the sinusoidal function, c.) using the calculated phase of the fitted sinusoidal function to determine a sampling offset that corresponds to the difference between the calculated phase of the fitted sinusoidal function and the desired phase of the fitted sinusoidal function, and d.) correcting the sampling timing using the determined sampling offset. In some embodiments, the sinusoidal function is cosine-like and the desired phase of the sinusoidal function is the phase where an extrema (i.e., a minimum or a maximum of the function) is located at the exact center of the symbol period (i.e., as shown in FIG. 3B). In some embodiments, the sinusoidal function is sine-like and the desired phase of the sinusoidal function is the phase where a zero value is located at the exact center of the symbol period. In some embodiments, the fitting can be done using a different function, such as a saw-tooth function, or a continuous polynomial function, or a piece-wise continuous polynomial function. In other embodiments, the fitting can be done using a relationship contained in a look-up-table (LUT) that may or may not be described by a mathematical function. Correcting the sampling timing can be performed by providing the sampling offset information as feedback to the ADC that is sampling the signal (e.g., processing block 210 in FIG. 2A) to correct (or recover) the timing of the sampled signals, or as feedback to the interpolation processing block (e.g., processing block 215 in FIG. 2B) to correct (or recover) the timing of the previously sampled signals.

In some embodiments, a timing recovery method includes frequency domain operations. In some embodiments, a timing recovery method includes receiving a signal, sampling the signal using an ADC using an initial sampling offset, determining an absolute value of the sampled signal, raising the absolute value of the signal to the fourth power, generating a spectral domain representation of the absolute value of the sampled signal, determining a dominant signal energy peak in the spectral domain, and adjusting the sampling offset to maximize the dominant signal energy peak in the spectral domain. In some embodiments, the absolute value of the signal can be raised to a power higher or lower than the fourth power (e.g., 2^{nd} power, 8^{th} power, or 12^{th} power) before generating the spectral domain representation. An example of the signal in the spectral domain after the fourth power of the absolute value is taken is shown in FIG. 1D.

In some embodiments of the timing recovery method above, adjusting the sampling offset to maximize the dominant signal energy peak in the spectral domain includes: a.) determining four or more multiple signal energy values of the dominant peak in the spectral domain which correspond to multiple respective sampling offsets (e.g., 4, or 6, or 8, or 10, or from 4 to 10), b.) fitting a sinusoidal function to the multiple signal energy values, and c.) using the sinusoidal function to determine a sampling offset that maximizes the dominant signal energy peak amplitude in the spectral domain. In some embodiments, the fitting can be done using a different function, such as a saw-tooth function, or a continuous polynomial function, or a piece-wise continuous polynomial function. In some embodiments, the fitting can be done using a relationship contained in a look-up-table (LUT) that may or may not be described by a mathematical function.

The timing recovery methods with frequency domain operations described above work well for Nyquist pulses with ROF less than 0.1, or less than 0.01, or from 0.001 to 0.1. For this method, a lower ROF is advantageous, because as ROF gets larger (e.g., 0.1, or 0.2, or greater), the dominant peak at the center of the spectrum carries less power, and responds with a smaller variation when the delays are applied, which makes the sinusoidal fit more difficult.

Similar to the timing recovery performed in the time domain, the sampling offset that maximizes the dominant signal energy peak amplitude in the spectral domain (i.e., the phase shift needed for timing recovery) can be fed back to the ADC for timing correction of future sampled signals, or to an interpolation stage to correct the timing of previously sampled signals.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

1. A timing recovery method, comprising:
a. receiving a signal comprising Nyquist shaped pulses
b. sampling the signal using an analog-to-digital converter at a sampling rate;
c. generating a plurality of delayed sampled signals from the sampled signal, wherein each delayed sampled signal has a different sampling delay;
d. resampling each delayed sampled signal to 1 sample per symbol;
e. taking the absolute value of each resampled signal;
f. raising the absolute value of each resampled signal to the fourth power;
g. taking the mean of the fourth power of the absolute value of each resampled signal;
h. feeding all of the mean values into a phase estimator; and
i. using an output from the phase estimator for timing correction.

2. The timing recovery method of claim 1, further comprising:
feeding the output of the phase estimator back to the analog-to-digital converter for timing correction.

3. The timing recovery method of claim 1, further comprising:
feeding the output of the phase estimator to an interpolating stage for timing correction, wherein the interpolating stage adjusts sampling instants of the sampled signals output from the analog-to-digital converter to have corrected timing.

4. The timing recovery method of claim 1, wherein the signal is sampled 4 or more times.

5. The timing recovery method of claim 1, wherein:
the phase estimator fits the mean values to a sinusoidal function;
the output of the phase estimator comprises a phase of the sinusoidal function; and
the phase of the sinusoidal function is used for timing correction.

6. The timing recovery method of claim 1, wherein the signal is a quadrature amplitude modulated (QAM) signal, a pulse-amplitude modulated (PAM) signal, a quadrature phase shift keying (QPSK) signal, or a higher order QAM signal with order 16 or greater.

7. The timing recovery method of claim 1, wherein the signal is a digitally modulated signal with pulse shaping using a raised-cosine filter having a roll-off factor less than 0.2.

8. The timing recovery method of claim 1, wherein the sampling rate ranges from a rate equal to the Nyquist frequency to less than 2 samples per symbol, and the resampling is performed using interpolation.

9. The timing recovery method of claim 1, wherein the sampling rate is at 2 samples per symbol, and the resampling is performed using decimation.

10. The timing recovery method of claim 1, wherein a frequency recovery process is performed after step b.) and before step c.).

11. A timing recovery method, comprising:
a. receiving a signal comprising Nyquist shaped pulses;
b. sampling the signal using an analog-to-digital converter at a sampling rate to generate a sampled signal;
c. delaying the sampled signal using a sampling delay to generate a delayed sampled signal;
d. resampling each delayed sampled signal to 1 sample per symbol to generate a resampled signal;
e. determining an absolute value of each resampled signal;
f. raising the absolute value of each resampled signal to the fourth power;
g. taking the mean of the fourth power of the absolute value of each resampled signal;
h. adjusting the sampling delay and repeating steps a.) through g.) with the adjusted sampling delay N times before proceeding to step i.) to generate N sampled signals with N delays;
i. feeding the N sampled signals with N delays into a phase estimator; and
j. using an output from the phase estimator for timing correction.

12. The timing recovery method of claim 11, further comprising:
feeding the output of the phase estimator back to the analog-to-digital converter for timing correction.

13. The timing recovery method of claim 11, further comprising:
feeding the output of the phase estimator to an interpolating stage for timing correction, wherein the interpolating stage adjusts sampling instants of the sampled signals output from the analog-to-digital converter to have corrected timing.

14. The timing recovery method of claim 11, wherein steps a.) through g.) are repeated with the adjusted sampling delay 4 times before proceeding to step i.).

15. The timing recovery method of claim 114, wherein:
the phase estimator fits the mean values to a sinusoidal function;
the output of the phase estimator comprises a phase of the sinusoidal function; and
the phase of the sinusoidal function is used for timing correction.

16. The timing recovery method of claim 11, wherein the signal is a quadrature amplitude modulated (QAM) signal, a pulse-amplitude modulated (PAM) signal, a quadrature phase shift keying (QPSK) signal, or a higher order QAM signal with order 16 or greater.

17. The timing recovery method of claim 11, wherein the signal is a digitally modulated signal with pulse shaping using a raised-cosine filter having a roll-off factor less than 0.2.

18. The timing recovery method of claim 11, wherein the sampling rate ranges from a rate equal to the Nyquist frequency to less than 2 samples per symbol, and the resampling is performed using interpolation.

19. The timing recovery method of claim 11, wherein the sampling rate is at 2 samples per symbol, and the resampling is performed using decimation.

20. The timing recovery method of claim 11, wherein a frequency recovery process is performed after step b.) and before step c.).

21. A timing recovery method, comprising:
a. receiving a signal comprising Nyquist shaped pulses;
b. sampling the signal using an analog-to-digital converter at a sampling rate using a sampling offset to generate a sampled signal;
c. determining an absolute value of the sampled signal;
d. raising the absolute value of the sampled signal to the fourth power;
e. generating a spectral domain representation of the fourth power of the absolute value of the sampled signal;
f. determining a dominant signal energy peak in the spectral domain; and
g. maximizing the dominant signal energy peak amplitude in the spectral domain by adjusting the sampling offset.

22. The method of claim 21, wherein adjusting the sampling offset to maximize the dominant signal energy peak amplitude in the spectral domain further comprises:
determining multiple signal energy values of the dominant signal energy peak in the spectral domain which correspond to multiple respective sampling offsets;
fitting a sinusoidal function to the multiple signal energy values; and
using the sinusoidal function to determine a sampling offset that maximizes the dominant signal energy peak amplitude in the spectral domain.

23. The method of claim 21, wherein the sampling offset that maximizes the dominant signal energy peak amplitude in the spectral domain is fed back to the analog-to-digital converter for timing correction.

24. The timing recovery method of claim 21, wherein the sampling offset that maximizes the dominant signal energy peak amplitude in the spectral domain is fed to an interpolating stage for timing correction, wherein the interpolating stage adjusts sampling instants of the sampled signals output from the analog-to-digital converter to have corrected timing.

25. The timing recovery method of claim 21, wherein the sampling rate ranges from a rate equal to the Nyquist frequency of the signal to less than 2 samples per symbol, and the resampling is performed using interpolation.

26. The timing recovery method of claim 21, wherein the sampling rate is at 2 samples per symbol, and the resampling is performed using decimation.
